(19) United States
(12) Patent Application Publication
(10) Pub. No.: US 2002/0023213 A1
(43) Pub. Date: Feb. 21, 2002

(54) Encryption system that dynamically locates keys

(76) Inventors: Tia Walker, Seattle, WA (US); Dennis Sita, Seattle, WA (US)

Correspondence Address: PERKINS COIE LLP, PATENT-SEA, P.O. BOX 1247, SEATTLE, WA, 98111-1247, US

(21) Appl. No.: 09/882,374

(22) Filed: Jun. 12, 2001

Related U.S. Application Data
(60) Provisional application No. 60/211,025, filed on Jun. 12, 2000.
(60) Provisional application No. 60/248,282, filed on Nov. 14, 2000.

(51) Int. Cl. H04L 9/00

(52) U.S. Cl. 713/168; 380/286

(57) ABSTRACT

A method and system for encrypting digital data. In one embodiment, the encryption system allows a sender to encrypt digital data by first attempting to retrieve a locking key for the recipient from a local key store that is stored locally at the sender's computer. If the locking key cannot be retrieved from the local key store, then the encryption system retrieves the recipient's locking key from a key server. The recipient may have previously published their locking key with the key server. The encryption system then encrypts the digital data using the retrieved locking key. The sender can then forward the encrypted digital data to the recipient.

### CROSS REFERENCE TO RELATED APPLICATION

This application claims the benefit of U.S. Provisional Application Nos. 60/211,025, filed Jun.12, 2000, and 60/248,282, filed Nov.14, 2000,currently pending and incorporated herein by reference.

### TECHNICAL FIELD

The described technology relates generally to encryption techniques and particularly to techniques for locating and generating keys.

### BACKGROUND

Many different types of encryption techniques are currently used to ensure the security of digital data. One popular encryption technique is asymmetric encryption using public and private key pairs, such as the RSA encryption technique. When two people or more generally, to users such as people, computers, computer components, and so on want to securely exchange digital data, each person creates a public and private key pair. A key is a very large number. A public and private key pair has the characteristic that digital data encrypted (i.e., transformed from an original form of the digital data into a secure form by an algorithm that uses one key of the pair) with the public key can be in decrypted (i.e., transformed from the secure form of the digital data back to the original form by algorithm that uses the other key of the pair) with the private key and that digital data encrypted with the private key can be decrypted with the public key. Thus, one key of a public and private key operates as a locking key to secure the digital data and the other key operates as an unlocking key, and vice versa. After creating their public and private key pairs, the two people exchange their public keys and keep their private keys secret. To securely send digital data to the other person, the sender encrypts the digital data with the public key of the recipient. The sender then sends (e.g., via e-mail) the encrypted digital data to the recipient. When the recipient receives the encrypted digital data, the recipient decrypts the digital data using their private key. Because the recipient has kept their private key secret, the encrypted digital data can only be decrypted by the recipient and thus cannot be decrypted by someone who may intercept the encrypted digital data.

A recipient who receives encrypted digital data may not be sure whether the digital data was actually sent by the sender or an imposter. For example, someone may intercept the recipient's public key when it is sent to the sender. That interceptor could then encrypt forged digital data and send it to the recipient under the guise that is being sent by the sender. To prevent such forgery, a sender can “sign” their digital data using their private key. For example, a sender might first encrypt the digital data using the public key of the recipient and then encrypt the encrypted digital data using the sender's own private key. The recipient can then decrypt the digital data first using the sender's public key and then using the recipient's private key. If the digital data was not signed using the sender's private key, then the decryption using the sender's public key will convert the digital data into a meaningless form and the recipient will recognize that it was not signed by the sender. Since the sender has kept their private key secret, the recipient can be sure that the digital data was indeed encrypted by the sender.

One popular encryption system is the Pretty Good Privacy (“PGP”) encryption system. The PGP encryption system provides a PGP server and a PGP client. The PGP client may be a plug-in for an electronic mail program. The PGP client manages a key ring of public keys stored on each user's client computer. When digital data is to be encrypted, the PGP client retrieves the public key of the recipient from the key ring and encrypts the digital data with that public key. The PGP client also allows users to create public and private key pairs. The users can register their public keys with the PGP server. A sender wanting to send encrypted digital data can use the PGP server to export the recipient's public key and import the exported public key to the sender's key ring. A user could alternatively send their public key directly to another user (e.g., via email) so that the other user can import the public key into their key ring.

The use of encryption systems, such as the PGP encryption system, has been limited due, in part, to the difficulty in publishing public keys and in finding public keys. The use has also been limited because digital data can only be securely sent to users who have previously published their public keys. It would be desirable to have an encryption system that would improve upon these and other difficulties of current encryption systems.

### BRIEF DESCRIPTION OF THE DRAWINGS

FIG. 1 is a display page illustrating an example electronic mail message that is to be encrypted.

FIG. 2 is a display page illustrating a menu of the encryption system.

FIG. 3 is a display page illustrating an encrypted electronic mail message waiting to be sent.

FIG. 4 is a display page illustrating an encrypted electronic mail message that has been received by a recipient.

FIG. 5 is display page illustrating a decrypted electronic mail message.

FIG. 6 is a display page illustrating a logon dialog.

FIG. 7 is a display page illustrating downloading of a public and private key pair of a sender.

FIG. 8 is a display page illustrating establishing a password for a public and private key pair.

FIG. 9 is a display page illustrating a notification that a public and private key pair has been downloaded.

FIG. 10 is a display page illustrating status of retrieving the public key of the recipient from the local key store.

FIG. 11 is a display page illustrating status of retrieving a public key of a recipient from the key server.

FIG. 12 is a display page illustrating entry of a password for signing of an electronic mail message.

FIG. 13 is a display page illustrating electronic mail messages received by a recipient in one embodiment.

FIG. 14 is a display page illustrating an encrypted electronic mail message received by a recipient who is not encryption enabled.

FIG. 15 is a display page illustrating a notification electronic mail message.

FIG. 16 is a display page illustrating a encrypted electronic mail message after a recipient has registered.

FIG. 17 is a display page illustrating a logging on of the recipient to the key server.

FIG. 18 is a display page illustrating a downloading the interim key pair for a recipient.

FIG. 19 is a display page illustrating providing of a password for an interim public and private key pair.

FIG. 20 is a display page illustrating notification of a successful download of an interim public and private key pair.

FIG. 21 is a display page illustrating entry of a password for decrypting an encrypted electronic mail message.

FIG. 22 is a block diagram illustrating components of the encryption system in one embodiment.

FIG. 23 is a flow diagram illustrating processing of a send message component of the client component in one embodiment.

FIG. 24 is a flow diagram illustrating processing of a receive message component of the client component in one embodiment.

FIG. 25A is a flow diagram illustrating processing of a logon component of the server component in one embodiment.

FIG. 25B is a flow diagram illustrating processing of a get public key component of the server component in one embodiment.

FIG. 26 is a flow diagram illustrating processing of a get interim public key component of the server component in one embodiment.

FIG. 27 is a flow diagram illustrating processing of a sender notification component of the server component in one embodiment.

FIG. 28 is a flow diagram illustrating processing of a register notified user component of the server component in one embodiment.

FIG. 29 is a flow diagram illustrating processing of a replace key component in one embodiment.

FIG. 30 is a flow diagram illustrating processing of the authentication system in one embodiment.

FIG. 31 is a block diagram illustrating components of an encryption mail server in one embodiment.

FIG. 32 is a flow diagram illustrating processing of the encrypt mail component of the encryption mail server in one embodiment.

FIG. 33 is a flow diagram illustrating processing of a decrypt web page component in one embodiment.

### DETAILED DESCRIPTION

A method and system for encrypting digital data is a provided. In one embodiment, the encryption system allows a sender to encrypt digital data by first attempting to retrieve a locking key (e.g., public key) for the recipient from a local key store that is stored locally at the sender's computer. If the locking key cannot be retrieved from the local key store (e.g., because it has never been stored in the local key store), then the encryption system retrieves the recipient's locking key from a key server. The recipient may have previously published their locking key with the key server. The encryption system then encrypts the digital data using the retrieved locking key. The sender can then forward the encrypted digital data to the recipient. If the recipient has no published locking key, then the key server may assign a new locking and unlocking key pair to the recipient. The key server then provides the new locking key to the sender and the new unlocking key to the recipient. When the recipient receives the digital data encrypted with the new locking key, the recipient can use the new unlocking key, which the recipient downloads from the key server, to decrypt the digital data. In this way, published locking keys can be automatically retrieved from a key server and encrypted digital data can be sent to recipients who have not even published their locking keys.

In one embodiment, the encryption system is used to encrypt electronic mail messages. After a sender has prepared an electronic mail message, the sender may request the encryption system to encrypt the electronic mail message. The encryption system may have a client component and a server component. The client component executing at the sender's client computer first checks the local key store to determine whether it contains a public key for the recipient's electronic mail address (or other type of recipient identifier). If no such public key is found in the local key store, the client component then sends to the key server a request for the public key associated with the recipient's electronic mail address. If a public key for the recipient's electronic mail address is stored at the key server, then the server component sends a response to the client component that includes the public key. If no public key for the recipient's electronic mail address is stored at the key server, then the server component may select a new public and private key pair and associate it with the recipient's electronic mail address. The server component then sends a response to the client component that includes the public key. Upon receiving the public key, the client component encrypts the electronic mail message using the public key. When the server component associates a new public and private key pair with the recipient's electronic mail address, it also sends a notification to the recipient's electronic mail address notifying the recipient that a public and private key pair has been assigned to the recipient and that the recipient will receive an electronic mail message encrypted using the new public key. The recipient can then access the key server to retrieve their new private key and decrypt the encrypted electronic mail message sent by the sender using their new private key.

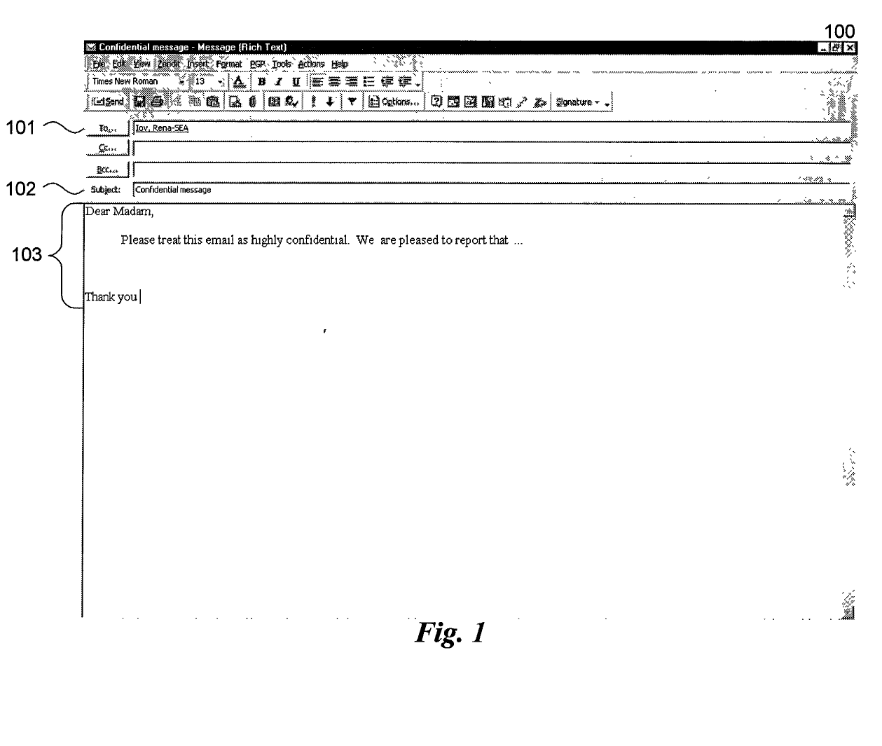

FIGS. 1-21 are display pages illustrating operation of the encryption system in one embodiment. In this embodiment, the encryption system works in conjunction with an electronic mail system to encrypt and send electronic mail messages. In this embodiment, the encryption system includes a plug-in for the electronic mail system, a client component, and a server component. The plug-in and the client component are installed at a client computer (e.g., the computer of the sender or recipient), and the server component is installed at the key server computer.

FIG. 1 is a display page illustrating an example electronic mail message that is to be encrypted. The display page 100 includes a to line 101 for entry of the recipient's electronic mail address, a subject line 102 for entry of subject information, and a text area 103 for entry of the text of the electronic mail message.

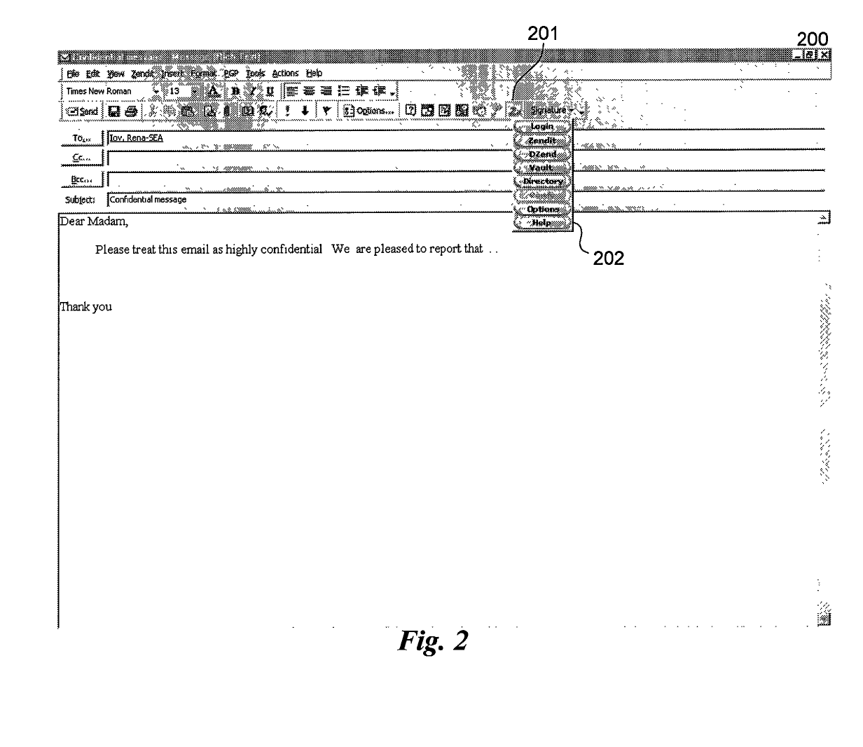

FIG. 2 is a display page illustrating a menu of the encryption system. The display page 200 includes an encryption button 201 and an encryption menu 202. When the sender selects the encryption button, the plug-in displays the encryption menu. In this example, the encryption menu includes a logon menu item (“Login”), a encrypt menu item (“Zendit”), a decrypt menu item (“DZend”), a key store access menu item (“Vault”), and a directory menu item (“Directory”). When a menu item is selected, the plug-in requests the client component to perform the behavior of associated with the menu item. The client component may execute as a process that is separate from the process of the electronic mail system. The log on menu item allows the sender to log on to the key server. The sender may have previously registered with the key server and provided a user name and password. To log on, the sender reenters their user name and password, which the client component sends to the key server. In one embodiment, the client computer and the key server may have established a connection using a protocol such as secure HTTP (i.e., “https”). The server component of the key server validates the user name and password and notifies the client component whether the sender has been authenticated and thus logged on. In one embodiment, the client component may require users of the encryption system to log on to the key server in order to use the encryption system. The encrypt menu item is used to retrieve the public key of the recipient from the local key store and encrypt the text of the electronic mail message. The decrypt menu item is used to retrieve the private key of the recipient from the local key store and decrypt an electronic mail message using the private key. The local store access menu item is used to view and maintain the keys stored in the local key store. The directory menu item is used to select the recipient from a list of recipients who have their public keys stored in the local key store.

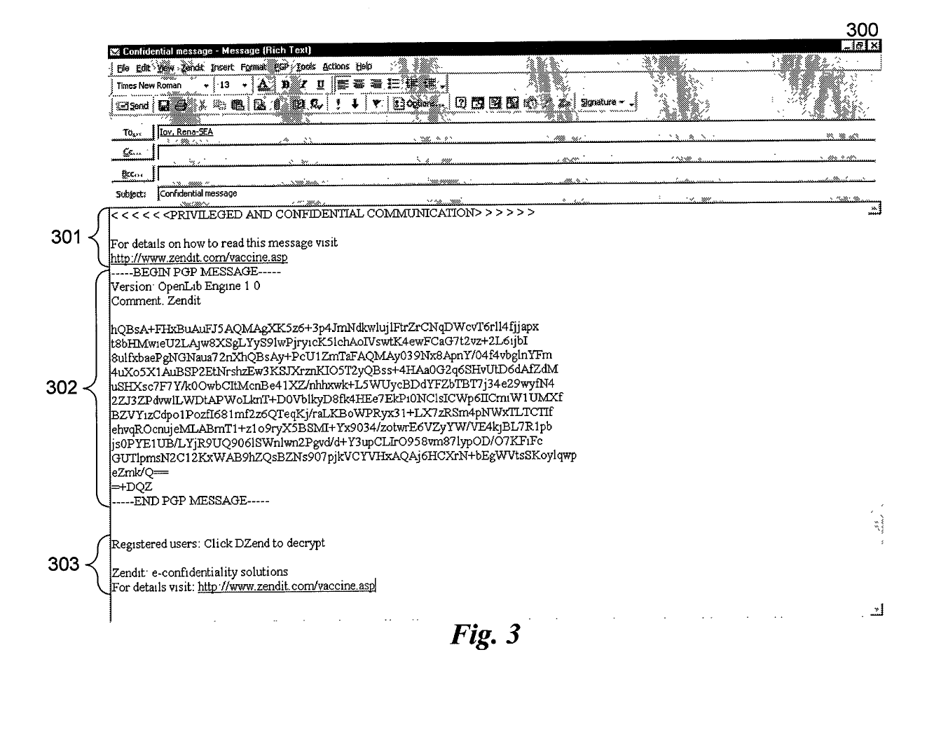

FIG. 3 is a display page illustrating an encrypted electronic mail message waiting to be sent. The display page 300 includes a header area 301, an encrypted text area 302, and a trailer area 303. The header area, which may be optional, contains information on how the recipient can decrypt the electronic mail message. The trailer area may contain similar type information. This information may be especially useful when a recipient has not used the encryption system to publish a public key or when the recipient is unaware of the encryption system. In one embodiment, the contents of the header and trailer areas may be customized to contain information relating to the organization (e.g., company) associated with the sender. For example, if the sender is an employee of a company, the client component may automatically add the company's logo or a company advertisement to the header area or trailer area. The encrypted text area contains the encrypted version of the text of the electronic mail message. In this example, the text is encrypted in accordance with the PGP encryption techniques. The client component may also encrypt documents attached to the electronic mail message. The sender selects the send button of the electronic mail system to send the encrypted electronic mail message to the recipient.

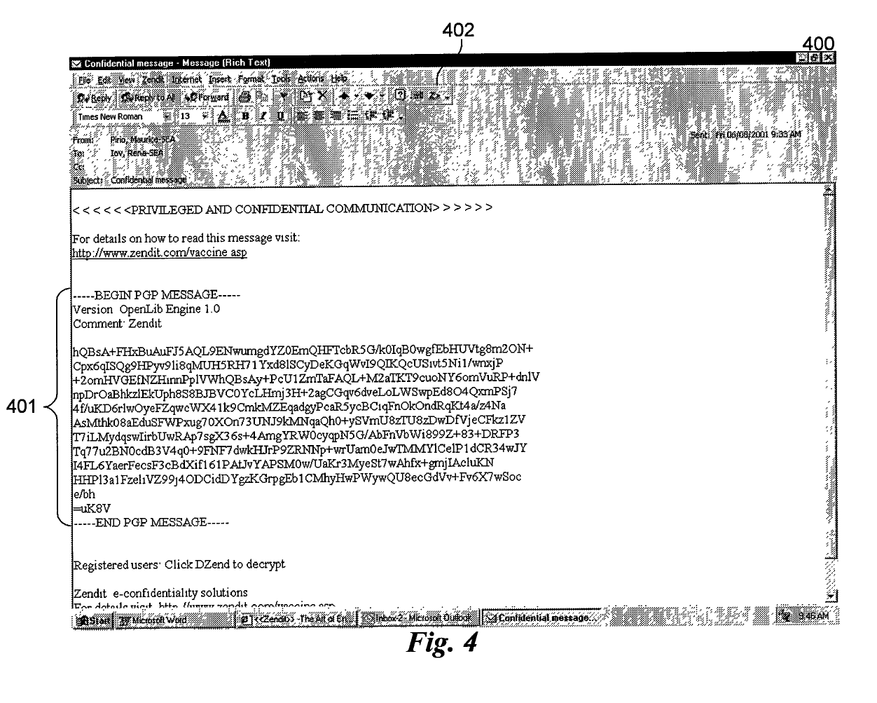

FIG. 4 is a display page illustrating an encrypted electronic mail message that has been received by a recipient. The display page 400 includes an encrypted text area 401 and encryption button 402. This electronic mail message corresponds to that of FIG. 3. To decrypt the encrypted text area, the recipient selects the encryption button and then the decrypt menu item. When the decrypt menu item is selected, the plug-in provides the encrypted text to the client component. The client component retrieves the private key for the recipient from the local key store and decrypts the encrypted text. If the recipient is not currently logged on to the key server, then the client component coordinates the logging on of the recipient.

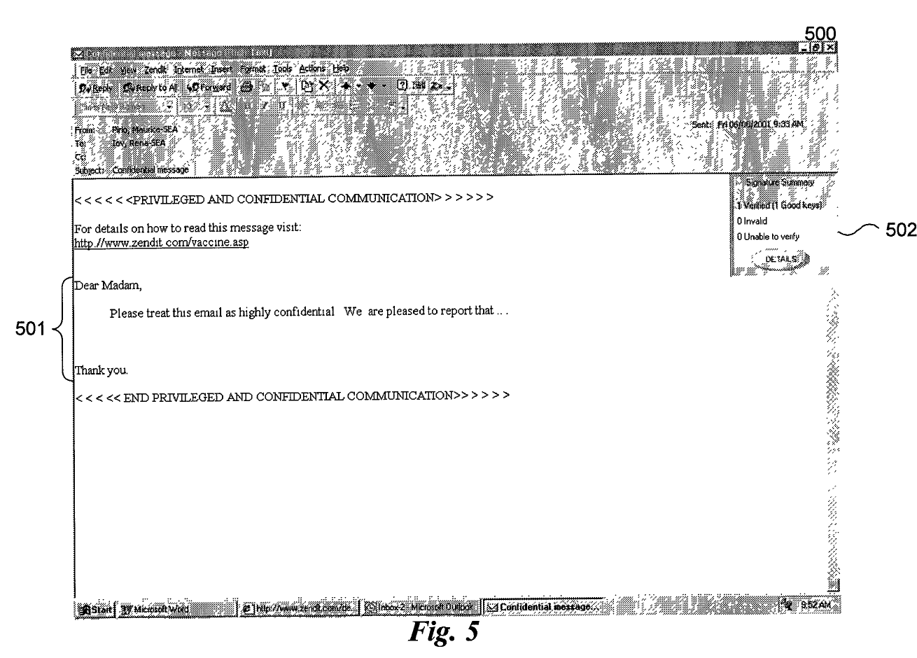

FIG. 5 is display page illustrating a decrypted electronic mail message. The display page 500 includes a decrypted text area 501 and a signature status area 502. The decrypted text area contains the decrypted text. The signature status area indicates whether the signature of the electronic mail message has been verified. In one embodiment, the client component may also remove the header and trailer areas.

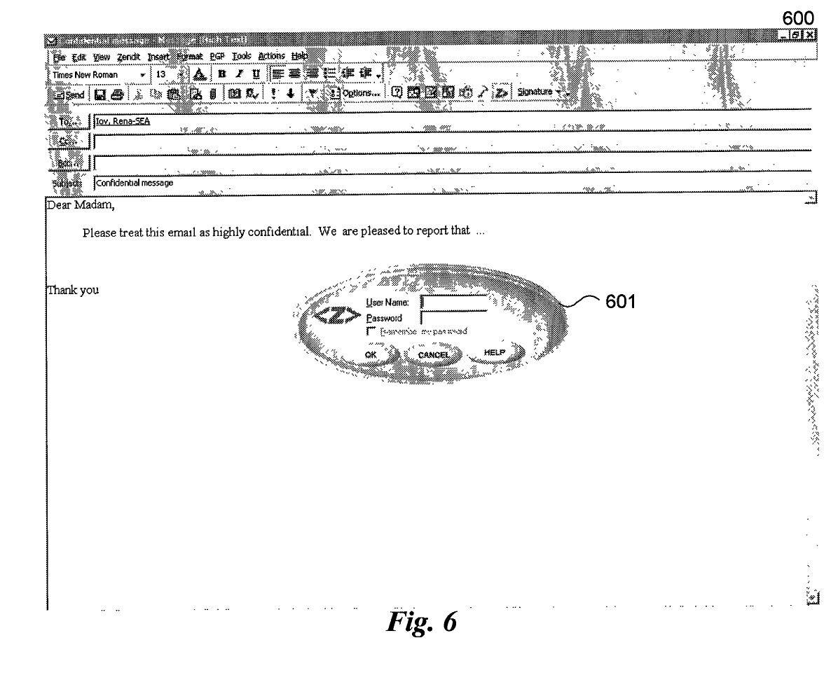

FIG. 6 is a display page illustrating a logon dialog. The display page 600 includes a logon dialog 601 that is displayed to the sender when the sender selects the logon menu item. Alternatively, the logon dialog may be displayed when the sender who is not currently logged on selects the encrypt menu item. The sender enters their user name and password and selects the OK button to log on. The client component then coordinates the logging on of the sender to the key server.

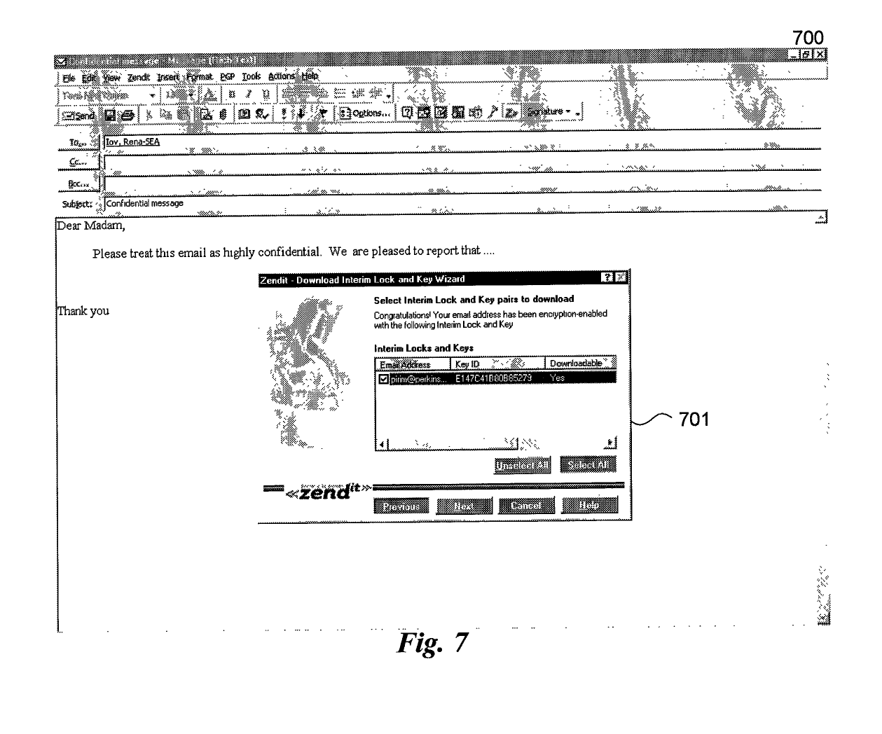

FIG. 7 is a display page illustrating downloading of a public and private key pair of a sender. The display page 700 includes a download dialog box 701. The download dialog box indicates that a interim public and private key pair is stored at the key server for the sender. The interim public and private key pair may have been created when the sender registered with the encryption system. To register, the sender provides a user name, a password, and an electronic mail address to the key server. The key server may assign a new public and private key pair to the sender. The sender may download their interim public and private key pair for storage in their local key store so that they can use their private key to sign electronic mail messages and decrypt electronic mail messages sent to them. The private key can be downloaded at the time of registration or deferred until the sender first signs or decrypts an electronic mail message. Alternatively, the client component may generate a public and private key pair and upload the public key to the key server at the time of registration. In this way, the sender can ensure that their private key is kept secure since not even the key server ever has access to the private key. The interim public and private key pair is considered “interim” because the key pair was provided by the key server and users may want to replace their interim public and private key pair with a key pair generated by their own client computers.

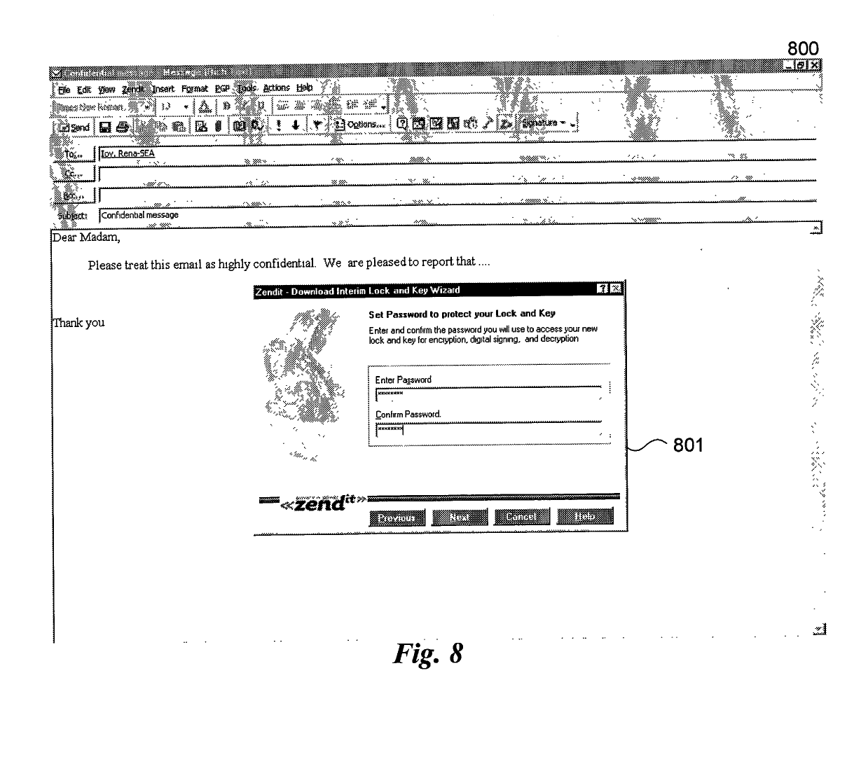

FIG. 8 is a display page illustrating establishing a password for a public and private key pair. The display page 800 includes a password dialog box 801. The sender provides a password for controlling access to their public and private key pair stored in their local key store. The client component stores the password in the local key store so that the user accessing the public and private key pair can be authenticated.

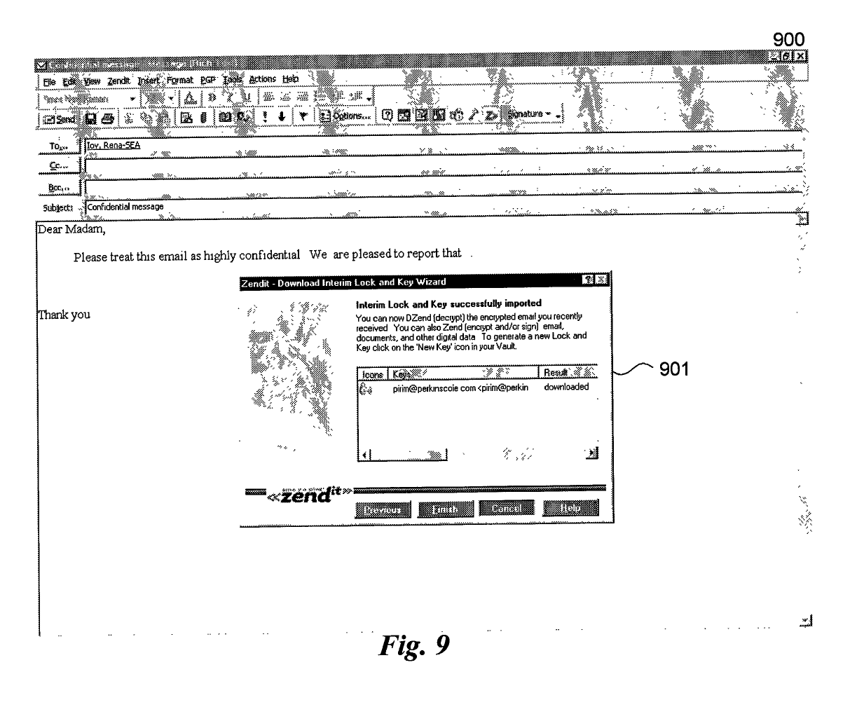

FIG. 9 is a display page illustrating a notification that a public and private key pair has been downloaded. The display page 900 includes a notification dialog box 901 which indicates that the public and private key pair has been downloaded and stored in the local key store.

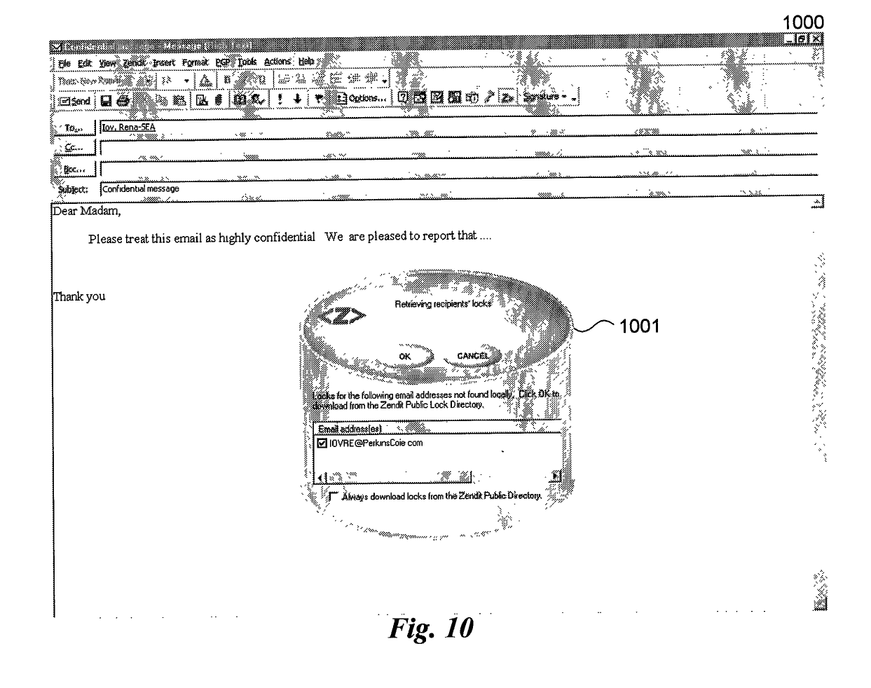

FIG. 10 is a display page illustrating status of retrieving the public key of the recipient from the local key store. The display page 1000 includes a status dialog 1001. In this example, the public key for the recipient has not yet been stored in the local key store. The status dialog prompts the sender to indicate whether the client component should attempt to retrieve the public key of the recipient from the key server.

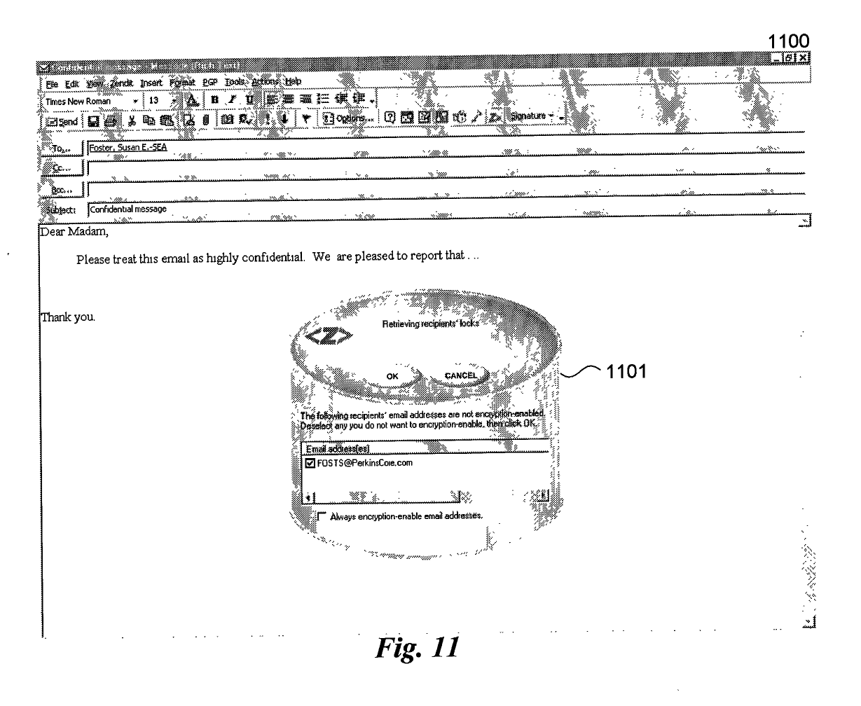

FIG. 11 is a display page illustrating status of retrieving a public key of a recipient from the key server. The display page 1100 includes a status dialog 1101. In this example, the public key of the recipient has not yet been stored by the key server. The status dialog prompts the sender to indicate whether an interim public and private key pair should be assigned to the recipient. The automatic assigning of a public and private key pair for such a recipient is referred to as “encryption enabling” the recipient. If an interim key pair is to be assigned, the server component selects a public and private key pair for the recipient and sends the interim public key to the client component of the sender's computer. The client component then encrypts the text of the electronic mail message using the interim public key of the recipient. The assigned public and private key pair are referred to as “interim” because the recipient has not yet verified whether they want to use that key pair or provide their own public and private key pair.

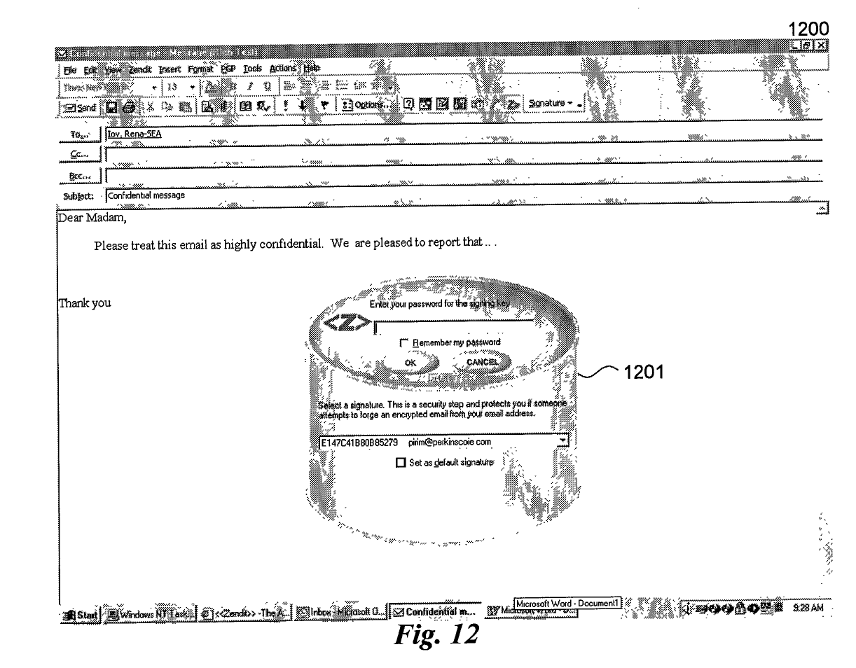

FIG. 12 is a display page illustrating entry of a password for signing of an electronic mail message. The display page 1200 includes a 15 password dialog 1201. The password dialog prompts the sender for the password associated with their public and private key pair stored in the local key store. If the entered password matches the stored password, then the client component signs the electronic mail message using the private key of the sender.

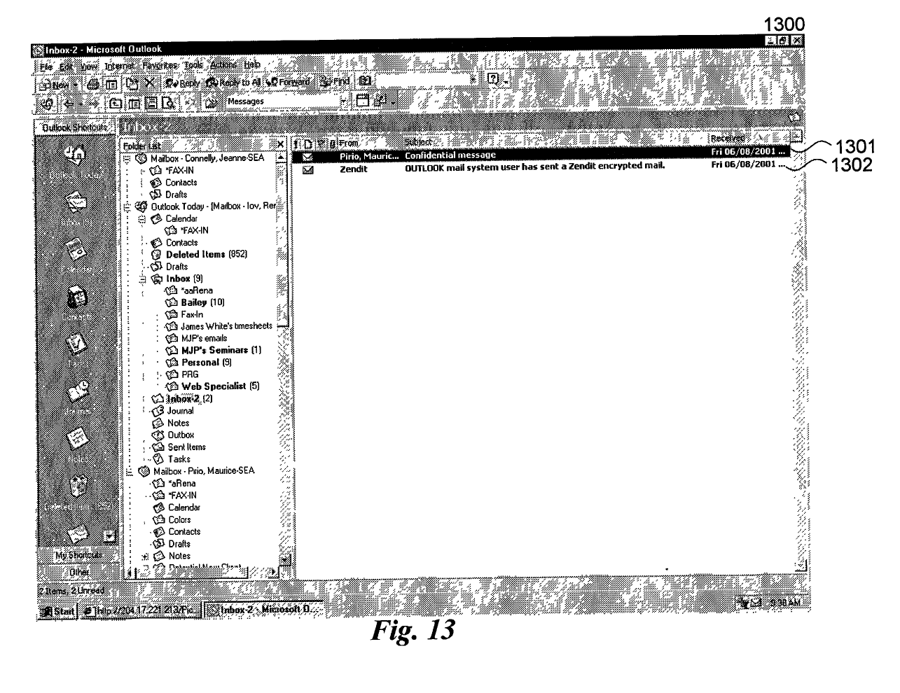

FIG. 13 is a display page illustrating electronic mail messages received by a recipient in one embodiment. The display page 1300 lists an encrypted electronic mail message 1301 and a notification electronic mail message 1302. The encrypted electronic mail message corresponds to the electronic mail message sent by the sender to the recipient. In the event that the recipient has not registered with the encryption system (i.e., was not encryption enabled), the encryption system encryption enabled the recipient by assigning an interim public and key pair to the recipient. The notification electronic mail message was sent by the key server to the recipient with instructions on how the recipient can register with the key server, download the plug-in and client component, and download their interim public and private key pair so that the encrypted electronic mail message can be decrypted.

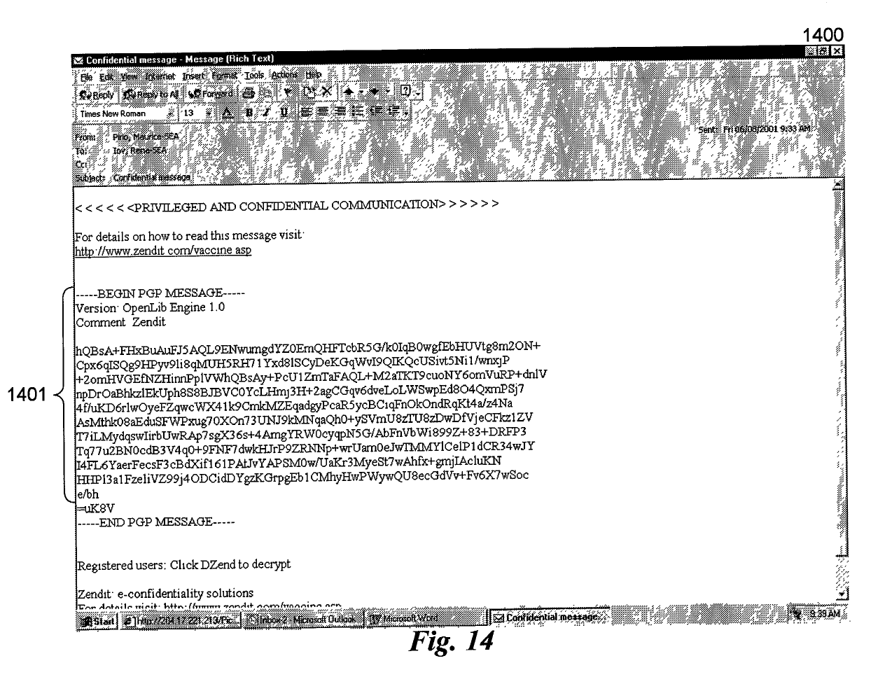

FIG. 14 is a display page illustrating an encrypted electronic mail message received by a recipient who is not encryption enabled. The display page 1400 includes an encrypted text area 1401. In this example, because the recipient has not yet registered with the encryption system, the recipient cannot decrypt the encrypted electronic mail message. The encryption button is not displayed because the plug-in has not yet been downloaded from the key server to the recipient's client computer.

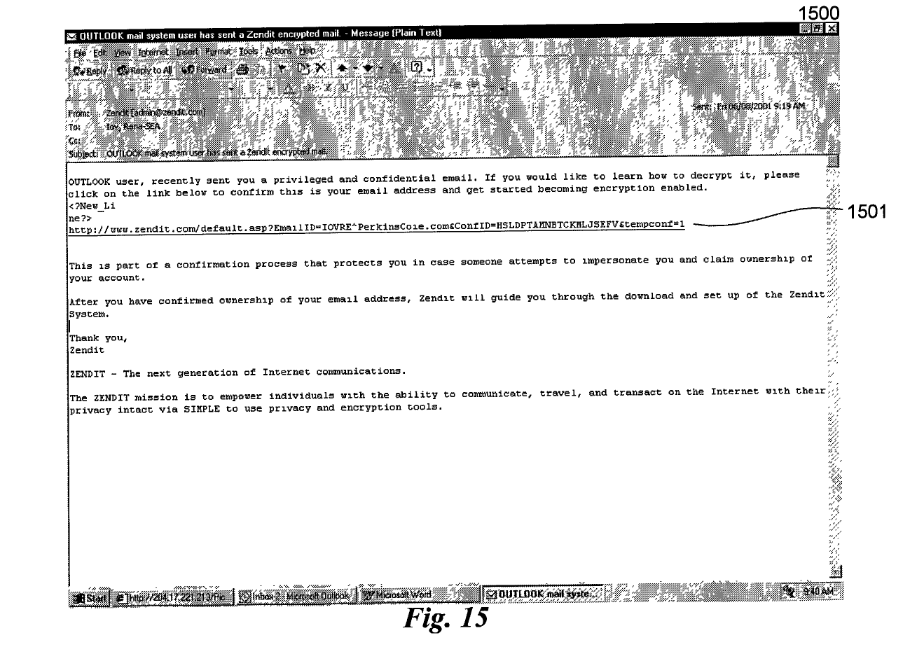

FIG. 15 is a display page illustrating a notification electronic mail message. The display page 1500 includes a link 1501 to a web page that allows the recipient to register with the key server, download the plug-in and the client component, and download their interim public and private key pair. In one embodiment, the notification electronic mail message may include a confirmation identifier or authentication code that the recipient provides to the key server during registration. This authentication code helps ensure that the person registering is the person who received the notification electronic mail message. In this example, the confirmation code is automatically added to the HTTP-request message that is sent from the recipient's computer to the key server when the link is selected.

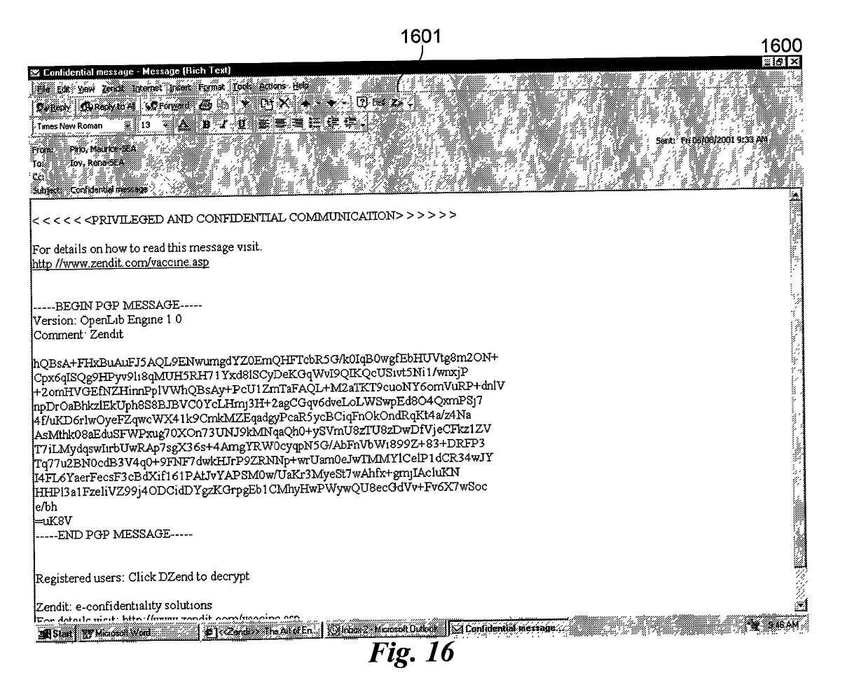

FIG. 16 is a display page illustrating an encrypted electronic mail message after a recipient has registered. The display page 1600 now includes an encryption button 1601. The encryption button is displayed by the downloaded plug-in. When the recipient selects the encryption button, the available menu items, including the decrypt menu item, are displayed.

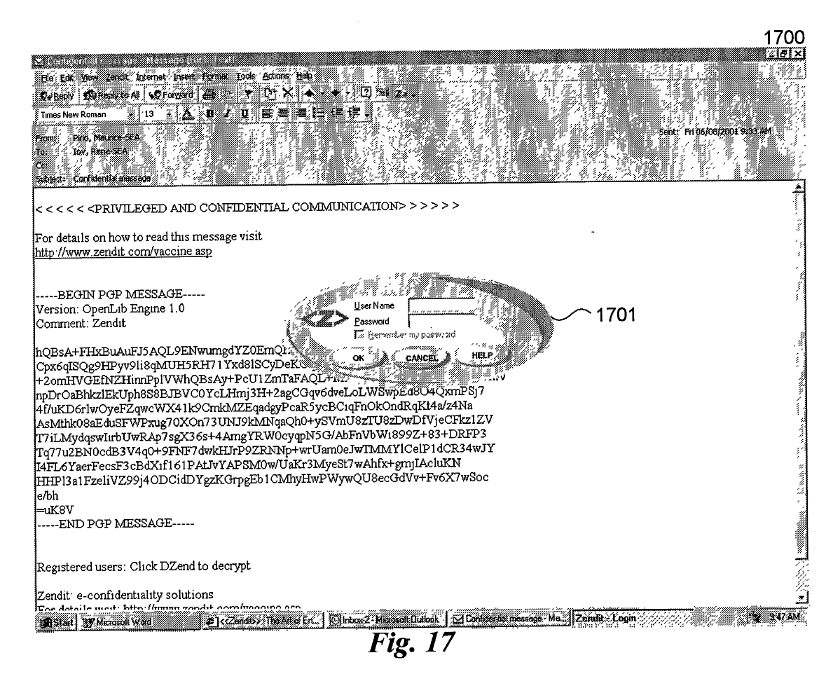

FIG. 17 is a display page illustrating logging on of a recipient to the key server. The display page 1700 includes logon dialog 1701. The recipient enters their user name and password into the logon dialog and selects the OK button to log on to the key server. The logon dialog may be automatically displayed when the recipient attempts to decrypt an electronic mail message and the recipient is not already logon. To log the recipient on, the client component sends a logon request with the entered user name and password to the key server. The server component verifies whether the user name is registered and the passwords match and logs the recipient on as appropriate. The server component then sends a response indicating whether the recipient was logged on.

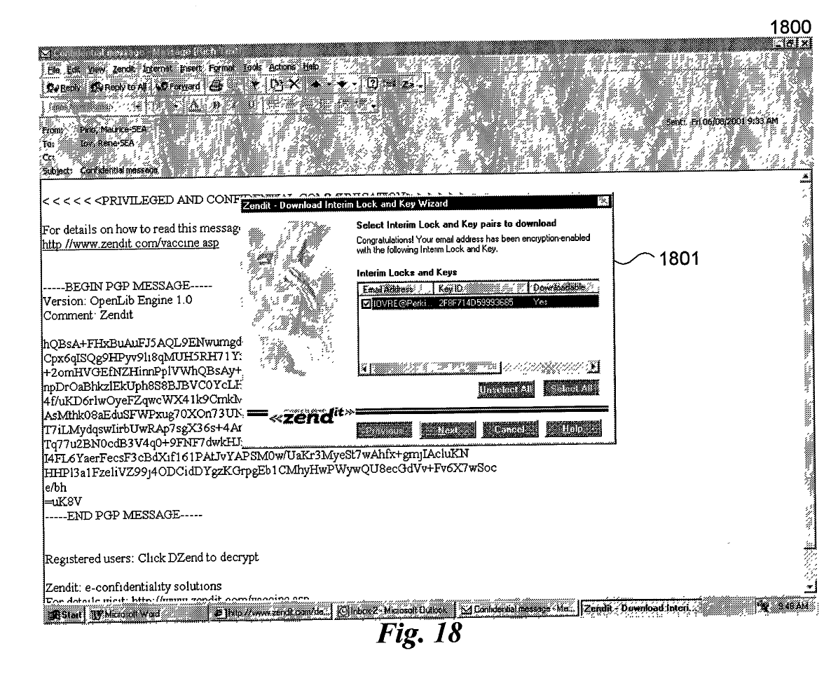

FIG. 18 is a display page illustrating downloading of interim key pair for a recipient. The display page 1800 includes a download dialog box 1801. The download dialog box allows the recipient to select the interim public and private key pair to be downloaded.

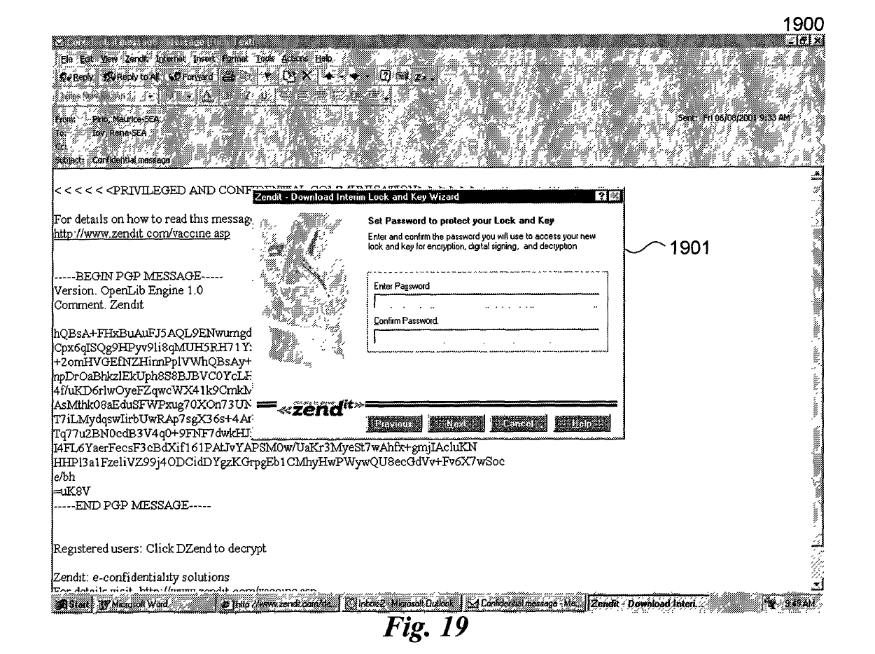

FIG. 19 is a display page illustrating providing of a password for an interim public and private key pair. The display page 1900 includes a password dialog box 1901. The recipient enters a password to be associated with the recently downloaded interim public and private key pair of the recipient. The client component stores the downloaded interim public and private key pair along with the entered password in the local key store.

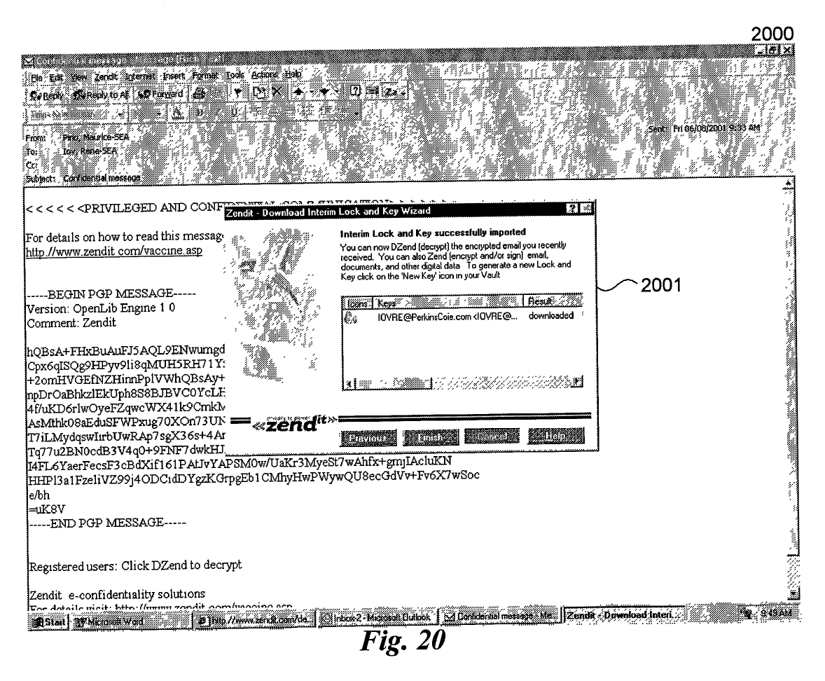

FIG. 20 is a display page illustrating notification of a successful download of an interim public and private key pair. The display page 2000 includes a notification dialog box 2001 indicating that the download was successful.

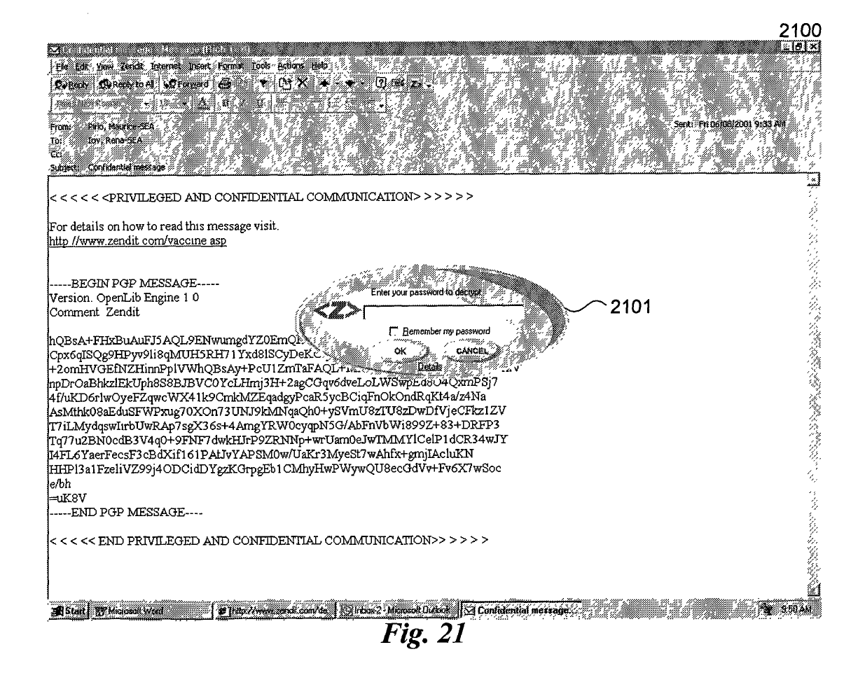

FIG. 21 is a display page illustrating entry of a password for decrypting an encrypted electronic mail message. The display page 2100 includes a password dialog 2101. The recipient enters a password for their public and private key pair. The client component ensures that the entered password matches the password associated with the public and private key pair that is stored at the local key store before providing access to the key pair.

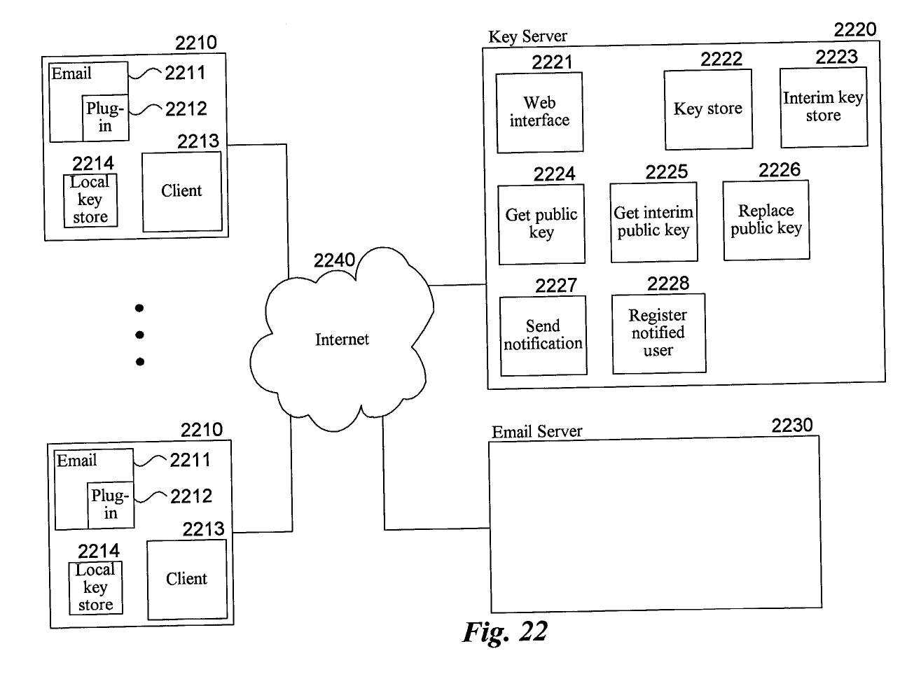

FIG. 22 is a block diagram illustrating components of the encryption system in one embodiment. The client computers 2210, the key server 2220, and the electronic mail server 2230 are interconnected via the Internet 2240. The client computers include an electronic mail system 2211 and include components of the encryption system such as a plug-in 2212, a client component 2213, and a local key store 2214. The plug-in is responsible for providing the encryption menu and coordinating with the client component to perform the behavior associated with a selected menu item. The client component receives requests from the plug-in and interacts with the key server to perform the requested behavior. The local key store contains the public and private key pairs for one or more users of the client computer and public keys for recipients of electronic mail messages. In one embodiment, the keys are stored in a PGP format that includes a name, an electronic mail address, a key identifier, an algorithm type (e.g., RSA), a key identifier, a creation date, an expiration date, and a key type (e.g., public or private).

The key server includes a web interface component 2221, a key store 2222, an interim key store 2223, a get public key component 2224, a get interim public key component 2225, a replace public key component 2226, a send notification component 2227, and a register notified user component 2228. The web interface component provides a web site through which users can register with the key server and download the plug-in and the client component. The key store contains an entry for each registered user of the key server. The entries may contain a user name, a password, and one or more pairs of an electronic mail address and a public key combination. The information in these entries allow a user to have multiple electronic mail addresses each with a different public key. Alternatively, the encryption system must allow a user to have one public key that is shared by multiple electronic mail addresses of that user. The key store may be indexed by user name to support rapid logon and registration processes and indexed by electronic mail address to support rapid location of public keys. The interim key store contains entries for each electronic mail address for which an interim public and private key pair has been assigned and but not yet downloaded by the user of that electronic mail address. The entries contain an electronic mail address and an interim public and private key pair. The electronic mail server receives electronic mail messages sent from sender client computers and forwards them to recipient client computers.

The computers may include a central processing unit, memory, input devices (e.g., keyboard and pointing device), output devices (e.g., display devices), and storage devices (e.g., disk drives). The memory and storage devices are computer-readable media that may contain computer instructions and data structures that implement the encryption system. One skilled in the art will appreciate that the concepts of the encryption system can be used in various environments other than the Internet and electronic mail systems. For example, the encryption system may be used it to encrypt digital data stored by a file system, to encrypt messages of a web-based electronic mail system (e.g., Hotmail.com), to encrypt content of web pages, and so on. Also, various communication channels such as a local area network, a wide area network, or a point-to-point dial-up connection may be used instead of the Internet. The computers may comprise any combination of hardware and software that can support these concepts. In particular, the key server may include multiple computers. For example, the web site provided by the encryption system may be provided by a web server that is separate from the key server. Also, one skilled in the art will appreciate that many different types of encryption techniques may be used with the encryption system.

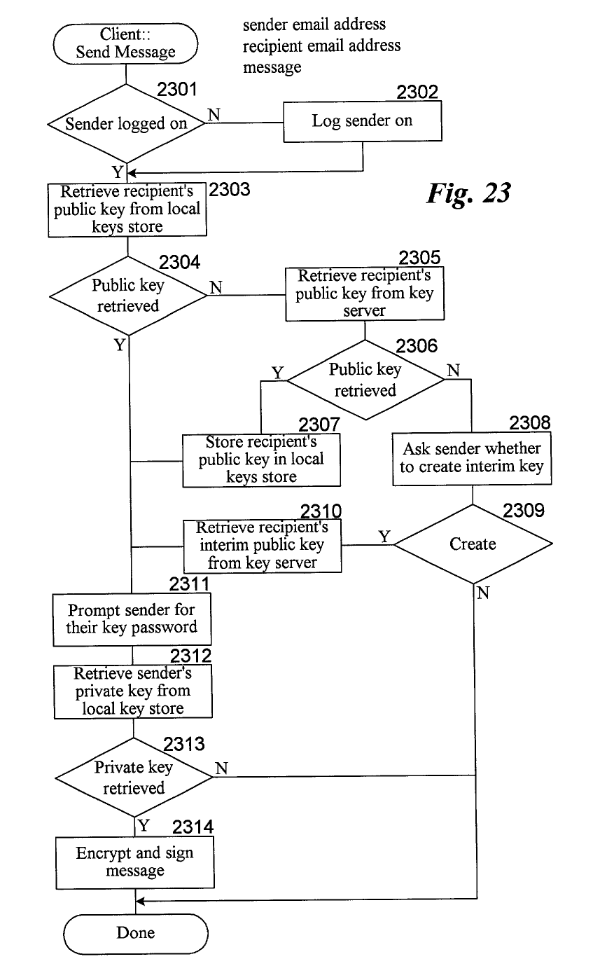

FIGS. 23-33 are flow diagrams illustrating example processing of various components of the encryption system in one embodiment. One skilled in the art will appreciate that the functions provided by the encryption system may be performed by a variety of different component organizations. Moreover, these flow diagrams illustrate the overall processing of the functions of the components. The actual implementations of these components will vary depending on the constraints and goals of the implementation.

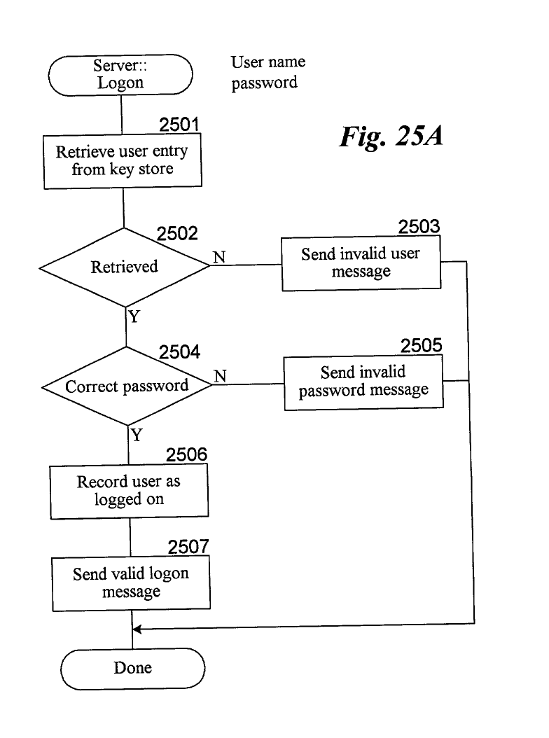

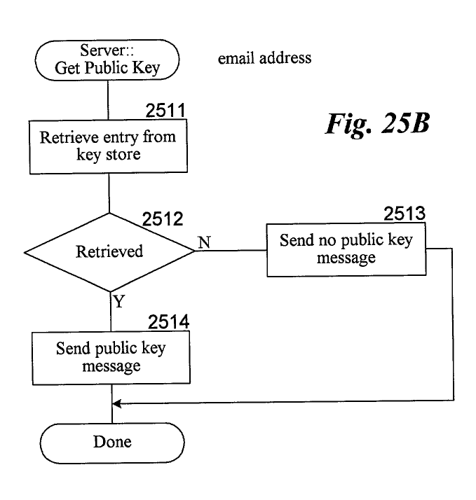

FIG. 25A is a flow diagram illustrating the processing of a logon component of the server component in one embodiment. The logon component coordinates the logging on of a user to the key server. The logon component may be invoked when the server component receives a logon request message from a client component. The component is passed a user name and password. The encryption system may require all users (e.g., senders and recipients) to log on before using the encryption system. The encryption system may establish and maintain a secure connection between the user's computer and the key server while the user is logged on. In block 2501, the component retrieves the entry for the user name from the key store. In decision block 2502, if an entry for the user name was retrieved, then, the user had been registered and the component continues at block 2504, else the component continues at block 2503. In block 2503, the component sends an invalid user name response message to the client component and then completes. In decision block 2504, if the passed password matches the password in the retrieved entry, then the user is authenticated and the component continues at block 2506, else the component continues at block 2505. In block 2505, the component sends an invalid password response message to the client component and then completes. In the block 2506, the component records the user as being logged on by updating the user's entry in the key store. In block 2507, the component sends a valid logon response message to the client component and then completes.

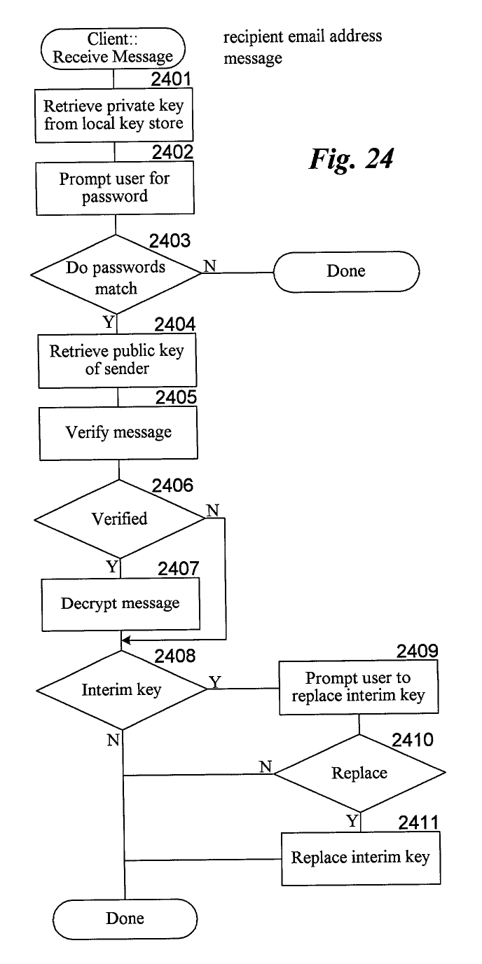

FIGS. 23-24 are flow diagrams illustrating processing of the client component in one embodiment. FIG. 23 is a flow diagram illustrating processing of a send message component of the client component in one embodiment. The send message component may be invoked by the plug-in when the sender indicates to encrypt an electronic mail message. The component is passed the user name of the sender, the recipient's electronic mail address, and the message to be encrypted. In decision block 2301, if the sender is currently logged on to the key server, then the component continues at block 2303, else the component continues at block 2302. In block 2302, the component coordinates the logging on of the sender to the key server. The key component sends a logon request message to the key server. In block 2303, the component retrieves the recipient's public key from the local key store. In decision block 2304, if the public key is retrieved from the local key store, then the component continues at block 2307, else the component continues at block 2307. In block 2307, the component stores the recipient's non public key, which is a non-interim public key, in the local key store. In block 2308, the component retrieves the recipient's public key from the key server. In decision block 2306, if the public key is retrieved from the key server, then the component continues at block 2320, else the component continues at block 2317. In block 2308 the component asks the sender whether to assign an interim key for the recipient. In decision block 2310, if the sender indicated to create an interim key, then the component continues at block 2310, else the component completes. In block 2310, the component retrieves the recipient's interim public key from the key server. In one embodiment, the component does not store the interim public keys of recipients in the local key store. Thus, the next time a electronic mail message is to be sent to the recipient, the component will attempt to retrieve the public key after the key server, which may by then be the recipient's permanent public key. In block 2311, the component prompts the sender for password for their key pair when the electronic mail message to be signed by the sender. In block 2312, the component retrieves the sender's private key from the local key store. In decision block 2313, if the private key was successfully retrieved the entered password matches the password for the private key, then the component continues at 2314, else the component completes. In block 2314, the component encrypts electronic mail message using the retrieved recipient's public key and signs electronic mail message using the sender's private key. The component then returns the encrypted and signed message to the plug-in so that it can be transmitted to the recipient. The component then completes.

FIG. 24 is a flow diagram illustrating processing of a receive message component of the client component in one embodiment. The receive message component is responsible for decrypting a message to be sent to recipient electronic mail address. This component is invoked by the plug-in of the encryption system and is passed the message and the recipient electronic mail address. In block 2401, the component retrieves the private key from the local key store for the recipient electronic mail address. In block 2402, the component prompts the user for their password for their private key. In decision block 2403, if the entered password matches the password stored in local key store, then the component continues at block 2404, else the component completes. In block 2404, the component retrieves the public key of the sender from the local key store to verify the sender's signature. If the sender's public key is not stored in local key store, then the component retrieves the sender's public key from the key server. In block 2405, the component uses the sender's public key to verify that the message was signed by the sender's private key. In decision block 2406, if the signature has been verified, then the component continues at block 2407, else component continues at block 2408. In block 2407, the component decrypts the message. In decision block 2408, if the recipient's public and private key pair is an interim key, then the component continues at block 2409, else the component completes. In block 2409, the component prompts the user to make the interim key a permanent key. In decision block 2410, if the user indicates to make the interim key permanent or to replace the interim key with a permanent key, then the component continues at block 2411, else the component completes. In block 2411, the component coordinates the replacing of the interim public and private key pair with a permanent key pair or coordinates the changing of the interim status to permanent status. The component may create a new public and private key pair and send the new public key to the key server. The component performs this coordination with the key server. The component then completes.

FIG. 25-29 are flow diagrams illustrating processing of the server component the embodiment.

FIG. 25B is a flow diagram illustrating processing of a get public key component of the server component in one embodiment. The get public key component is passed an electronic mail address and returns the public key assigned to that electronic mail address. This component is invoked when a request for a public key is received from a client component. In block 2511, the component retrieves the entry from the key store corresponding to the passed electronic mail address. In decision block 2512, if an entry was successfully retrieved, then the component continues at block 2514, else the component continues at block 2513. In block 2513, the component sends a response message to the client component indicating that the electronic mail address has not yet been very assigned and then completes. In block 2514, the component sends a response message to the client component that includes the public key for the electronic mail address and then completes.

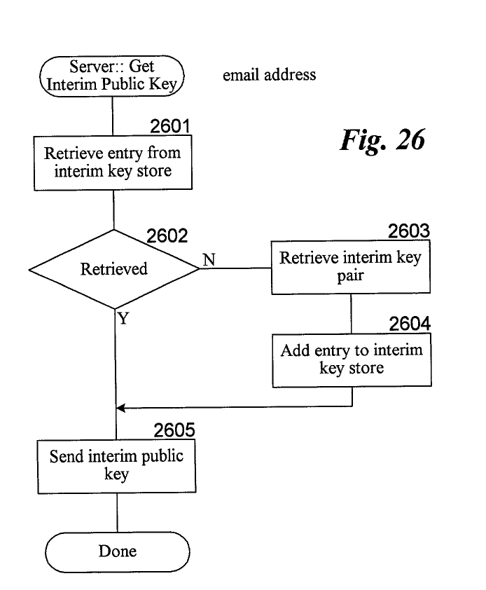

FIG. 26 is a flow diagram illustrating processing of a get interim public key component of the server component in one embodiment. The get interim public key component is passed an electronic mail address and returns an interim public key. This component is invoked when the key server receives a request from a client component to provide an interim public key. The component checks whether an interim public and private key pair has been previously assigned to the passed electronic mail address and is so, reuses'it. In block 2601, the component retrieves an entry from the interim key store for the passed electronic mail address. In decision block 2602, if an entry was successfully retrieved, then the component continues at block 2605, else the component continues at block 2603. In blocks 2603-2604, the component assigns a new public and private key pair to the electronic mail address. In block 2603, the component retrieves an interim public and private key pair. In one embodiment, the key server may have a table of previously generated public and private key pairs to avoid the overhead of dynamically creating public and private key pairs. When using the PGP format of public and private key pairs, the component replaces the electronic mail address of the previously created public and private key pair with the passed electronic mail address. In block 2604, the component adds an entry to the interim key store for the interim public and private key pair. In block 2605, the component sends to the client component a response message that includes the interim public key and then completes.

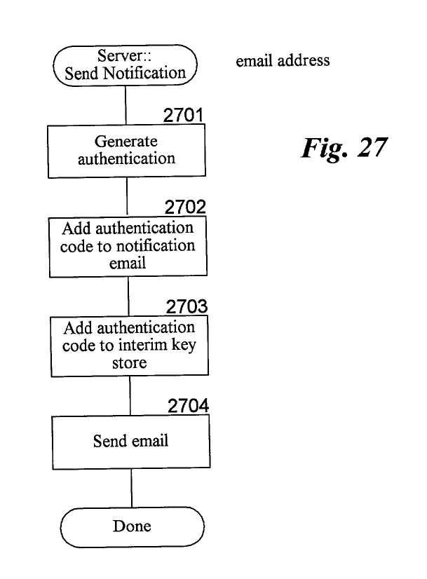

FIG. 27 is a flow diagram illustrating processing of a sender notification component of the server component in one embodiment. This component is passed the electronic mail address of the recipient to which a notification is to be sent. The notification is sent to recipients who are not yet registered with the key server. This component is invoked when an interim public and private key pair is assigned to recipient or when a previously assigned interim public key is provided to a sender. In block 2701, the component generates an authentication code for the recipient to be provided when the recipient registers with the key server. In block 2702, the component adds the authentication code to the notification electronic mail message. In block 2703, the component adds the authentication code to the entry in the interim key store for the recipient's electronic mail address. In block 2704, the component then sends the notification electronic mail message to the recipient electronic mail address. The component then completes.

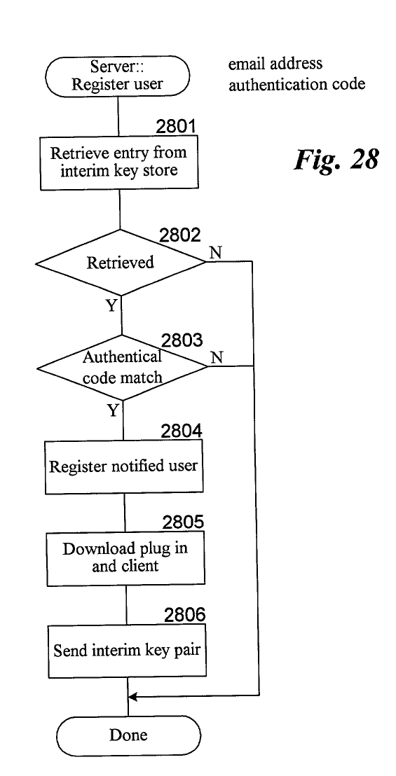

FIG. 28 is a flow diagram illustrating processing of a register notified user component of the server component in one embodiment. The register notified user component is invoked to register with the key server a recipient who has been notified that they have been encryption enabled. The component is passed the recipient electronic mail address and the authentication code provided by the recipient. The electronic mail message and authentication code may be automatically provided to the key server when the recipient selects a link provided in the notification electronic mail message. In block 2801, the component retrieves the entry for the electronic mail address from the interim key store. In decision block 2802, if the record was successfully retrieved, then the component continues at block 2803, else the component completes. In decision block 2803, if the authentication code provided by the recipient matches the authentication code in the retrieved entry, then the component continues at block 2804, else the component completes. In block 2804, the component coordinates the registration of the recipient. The recipient may be provided with a web page through which they can download the plug-in and client component and provide their user name and password. The key server then added entry to the key store for the recipient. In block 2805, the component transmits the plug-in and the client component to the recipient's computer. In block 2806, the component sends the interim public and private key pair to the recipient's computer, adds a record to the key store, removes the record from the interim key store, and then completes.

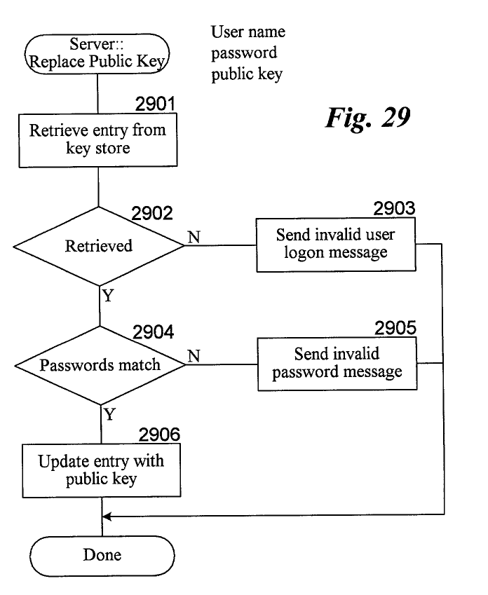

FIG. 29 is a flow diagram illustrating processing of a replace key component of the server component in one embodiment. The component is passed a user name, a password, and a public key. This component is invoked when a user wants to replace their current public key, which may be an interim key. In block 2901, the component retrieves an entry from the key store for the past username. In decision block 2902, if an entry was successfully retrieved, then the component continues at block 2904, else the component continues at block 2903. In block 2903, the component sends an invalid user name response message to the client computer and then completes. In decision block 2904, if the passed password matches the password in the retrieved entry, then the component continues at block 2906, else the component continues at block 2905. In block 2905, the component sends an invalid password response message to the client computer and then completes. In block 2906, the component updates the entry in the key store for the user name with the passed public key and then completes.

### Authentication Via Signature

A method and system for authenticating a user using the user's signature is provided. In one embodiment, the authentication system allows a user to log on to a server, such as a web server, by providing to the server a message signed with the user's private key. When the server receives the signed message, it verifies the signature of the message using the user's public key. If the signature is successfully verified, then the user has been authenticated and the server logs the user on. A conventional logon authentication process relies on the user providing their user name and password which is then compared to a previously stored user name and password. Since authentication via signature does not send a user name and password from the user's computer to the server, the user name and password cannot be intercepted and used by an impostor.

Authentication via signature may also facilitate the automatic logging on of a user to a server. For example, when a user requests an initial web page of a web server, the server may provide a web page that automatically coordinates the logon process using authentication via signature. The user's computer and a server may initially establish a connection, which may be secure. The initial web page may include a logon applet and a unique identifier generated by the server. The server may maintain a mapping from each unique identifier to the corresponding connection to the user's computer. When the web page is loaded, the applet may retrieve the private key of the user from the local key store at the user's computer. If the private key is password protected, then the applet may prompt the user for the password for the private key. The applet then encrypts the unique identifier using the private key and sends the encrypted unique identifier to the server along with a user identifier. The applet may retrieve the user identifier from the local key store. For example, the user identifier may be the user's electronic mail address associated with the only private key in the local key store. When the server receives the encrypted unique identifier and the user identifier through the connection, the server retrieves the public key of to that user identifier. The server may have a local table that maps user identifiers to public keys. Alternatively, the server may retrieve the public key for that user from a key server, such as the one described above for the encryption system. The server decrypts the encrypted unique identifier using the retrieved public key. The server then compares the decrypted unique identifier to the unique identifier it created for that secure connection. If the unique identifiers match, then the user has been successfully authenticated. In one embodiment, a common identifier may be used for all connections. The use of a common identifier may not, however, be as secure as the use of unique identifiers because if an interceptor intercepts a signed common identifier of a user, then the interceptor may use the intercepted signed common identifier to impersonate that user. In contrast, if an interceptor intercepts a signed unique identifier of a user, the interceptor cannot then use the intercepted unique identifier to subsequently impersonate that user because a signed unique identifier can only be used for authentication.

The authentication system may also automatically generate interim public and private key pairs for new users of a server. When the applet executing on the user's computer detects that no private key is stored in the local key store, the applet may assigned a public and private key pair to the user. The applet may create a public and private key pair at the user's computer or may request a key server to provide the key pair. The applet publishes the public key and stores the public and private key pair in the local key store. The applet may prompt the user for their electronic mail address so that the key server can identify the user. The applet may then receive the private key from the key server, or the key server may send and notification electronic mail message to the user's electronic mail address so that the user can coordinates the download of the private key.

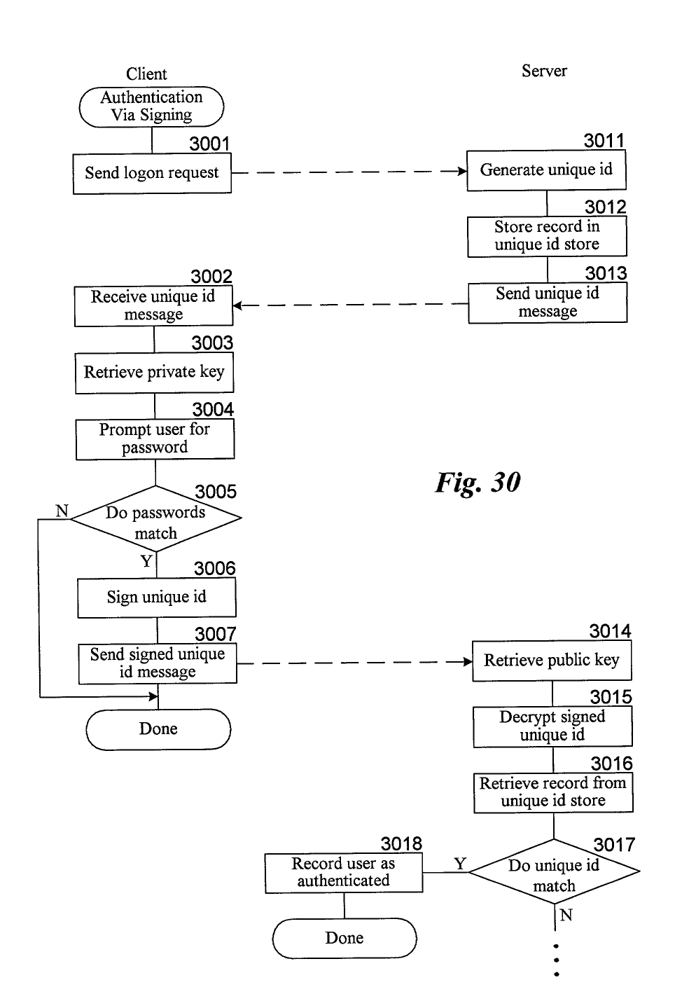

FIG. 30 is a flow diagram illustrating processing of the authentication system in one embodiment. Blocks 3001-3007 represent processing performed by a client computer, and blocks 3011-3018 represent processing by a server. In block 3001, the client computer may initially send a logon request message to the server after a secure connection is established with the server. In block 301 1, when the server receives the logon request message, it generates a unique identifier for the secure connection with the client computer. The unique identifier may be a large random number. In block 3012, the server records a mapping between the unique identifier and the secure connection. In block 3013, the server sends a response message containing the unique identifier to the client computer. In block 3002, the client computer receives the response message with the unique identifier. In block 3003, the client computer retrieves the private key of the user from the local key store. In block 3004, the client computer prompts the user for their password for the private key. In decision block 3005, if the entered password matches the password for the private key, then the client computer continues at block 3006, else the client computer completes. In block 3006, the client computer encrypts the unique identifier with the private key. In block 3007, the client computer sends a message with the signed unique identifier to the server. In block 3014, when the server receives the message with signed unique identifier, it retrieves the public key for the user. The server may have a local table of public keys or may retrieve the public key from a key server. In block 3015, the component decrypts the signed unique identifier using the retrieved public key. In block 3016, the server retrieves the unique identifier recorded for the secure connection. In decision block 3017, if the unique identifiers match, then the server continues at block 3018 to record the user as authenticated and proceeds with the logon process, else the server notifies the user that they cannot be authenticated.

### Encryption Mail Server

A method and system for automatically encrypting electronic mail messages is provided. In one embodiment, a encryption mail server receives electronic mail messages generated by senders. Upon receiving an electronic mail message, the encryption mail server retrieves a public key assigned to the recipient's electronic mail address. The encryption mail server then encrypts electronic mail message using the retrieved public key and forwards the encrypted electronic mail message to the recipient's of electronic mail addresses. The electronic mail server may also sign the encrypted electronic mail message with a private key of the encryption mail server. When the recipient receives the encrypted electronic mail message, the recipient can use the public key of the encryption mail server to verify that electronic mail message was sent via the encryption mail server. The encryption mail server may have a local key store that maps electronic mail addresses to public keys. If the encryption mail server does not have a public key for a recipient's electronic mail address, then the encryption mail server may request the public key from a key server, such as the one described above. If the key server does not have a public key for the recipient's electronic mail address, then the key server may generate an interim public and private key pair for the recipient. The key server then sends the interim public key to the encryption mail server and sends a notification electronic mail message to the recipient electronic mail address. The notification message notifies the recipient that an electronic mail message is being sent that has been encrypted with an interim public and private key that has been assigned to their electronic mail address. The notification also provides instructions to the recipient for retrieving their interim private key so that they can decrypt the electronic mail message when it is received. More generally, an encryption data server may be used to encrypt any type of digital data. That is, rather than encrypting just electronic mail messages, the electronic data server may be used to encrypt data stored in any type of files.

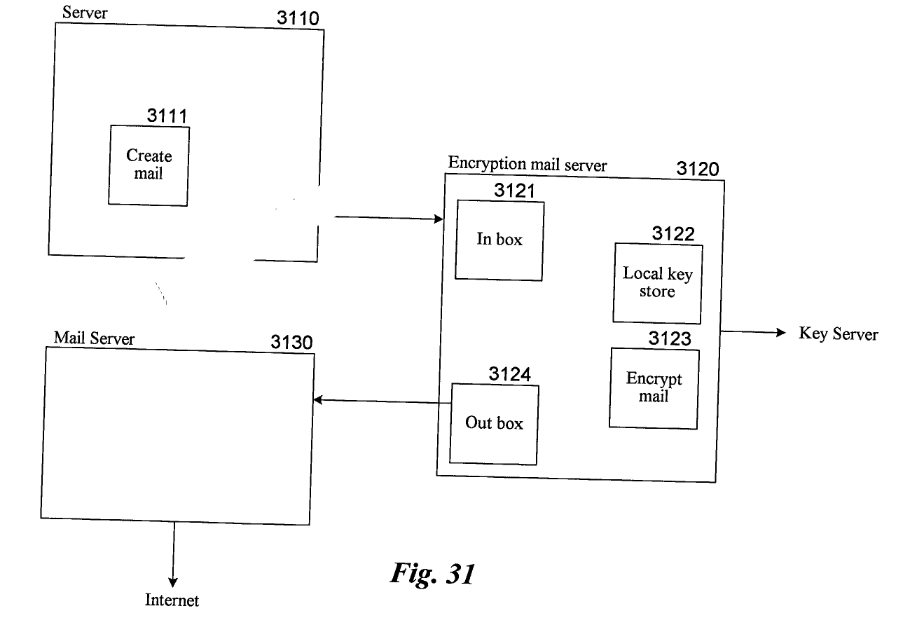

FIG. 31 is a block diagram illustrating components of an encryption mail server in one embodiment. A server 3110 is connected to an encryption mail server 3120. The encryption mail server 3120 may also be connected to mail server 3130. The server 3110 may have been originally connected to mail server 3130. To take advantage of the automatic encryption of the encryption mail server 3120, all electronic mail messages are routed from the server 3110 to the encryption mail server 3120, rather than to the mail server 3130. The encryption mail server 3120 encrypts the mail messages and forwards them to mail server 3130. The encryption mail server 3120 includes inbox 3121, local key store 3122, encrypt mail component 3123, and outbox 3124. The electronic mail messages received from server 3110 are stored in the inbox. The encrypt mail component upon receipt of an electronic mail message, or periodically, retrieves the electronic mail message from the inbox. The encrypt mail component retrieves the recipient's electronic mail address and then retrieves from the local key store the public key assigned to the recipient's electronic mail address. In one embodiment, the local key store may be a database of mappings from electronic mail addresses to public keys to facilitate the supporting of a large number of mappings. If the public key cannot be retrieved the local key store, then the encrypt mail component retrieves the public key from a key server. As described above, an interim public and private key pair may be assigned to the recipient's electronic mail address. The encrypt mail component stores the public key retrieved from the key server in the local key store. The encryption mail component then encrypts the electronic mail message with the retrieved public key and may sign the electronic mail message with a private key, such as one associated with the company that generated the electronic mail message. The encrypt mail component then stores the encrypted electronic mail message the outbox so that it will be forwarded to the mail server 3130 and eventually to the recipient's electronic mail address. One skilled in the art will appreciate that the encrypt mail component may alternatively be integrated with server 3110, rather than being part of a separate server.

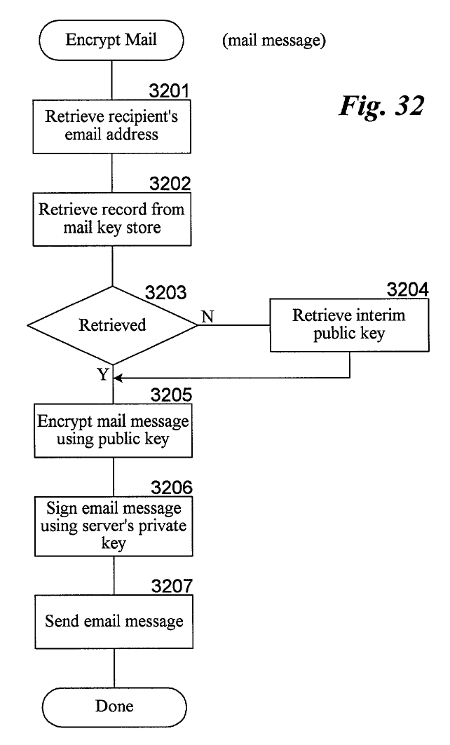

FIG. 32 is a flow diagram illustrating processing of the encrypt mail component of the encryption mail server in one embodiment. The component is passed an electronic mail message and the recipient's electronic mail address. In block 3201, the component retrieves the recipient's electronic mail address. In block 3202, the component retrieves an entry from the local key store for the recipient's electronic mail address. In decision block 3203, if an entry is successfully retrieved, then the component continues at block 3205, else the component continues at block 3204. In block 3204, the component retrieves a public key for the recipient's electronic mail address from a key server. The public key retrieved from the key server may be a permanent or an interim public key. In block 3205, the component encrypts the electronic mail message using the retrieved public key. In block 3206, the component signs the electronic mail message using a private key of the encryption mail server. In block 3207, the component sends the encrypted and signed electronic mail message to the recipient's electronic mail address and then completes.

### Encryption and Decryption of Web Pages

A method and system for automatically encrypting and decrypting web pages is provided. In one embodiment, an encrypt web page server may encrypt information contained in a web page provided by a web server before sending a web page to the requesting client computer. For example, a financial institution may want to encrypt a customer's financial information that is provided in a web page. A user may log on to the web server using conventional logon processing or authentication via signature logon processing. The web server then generates a web page in a conventional matter. The web server then forwards the web page to the encrypt web page server. The encryption web page server then uses the public key of the user to encrypt information of the web page. The encrypt web page server may be customized to decrypt only certain information on each web page. The encrypt web page server may retrieves the public key of users from a local key store or from a key server, such as the one described above. If the user has not been assigned a public key, then an interim public and private key pair can be generated by the key server as described above. The encrypt web page server then sends the web page with the encrypted information to the user's computer. Alternatively, the functionality of the encrypt web page server may be integrated with the web server itself. The user's computer may have a decrypt web page component that controls of the decrypting of encrypted information on the web pages received from the web server. The decrypt web page component receives a notification that a web page has been received and decrypts the encrypted information using the private key of the user. If an interim public and private key pair was assigned to the user, then the decrypt web page component may coordinate the downloading of the interim private key from the key server.

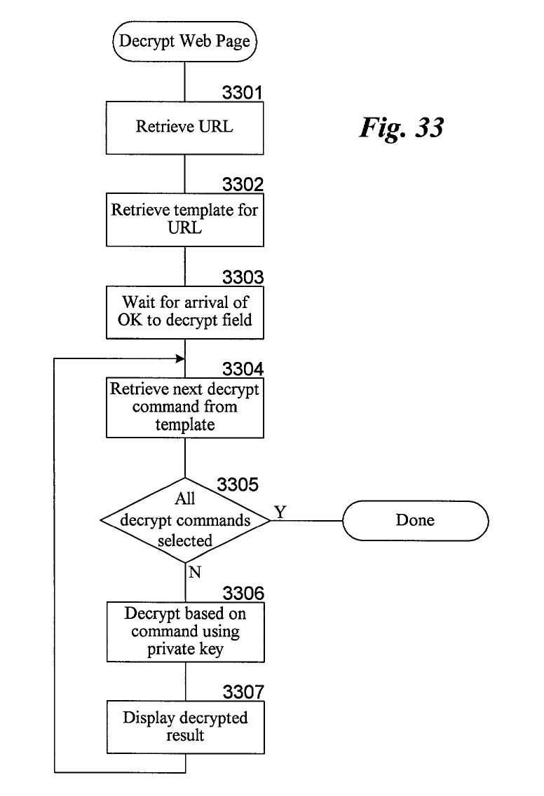

FIG. 33 is a flow diagram illustrating processing of a decrypt web page component in one embodiment. The decrypt web page component may have a mapping from web page uniform resource locators (“URLs”) to templates that describe how to decrypt the content of that web page and where to store the decrypted information. The template may also indicate a signal for the decrypt web page component to receive before it can start decrypting a web page. For example, the indicated signal may be the name of a field of the web page that needs to be received before decryption can start or reception of the entire web page before decryption can start. The decrypt web page component may provide a decrypt button so that a user may signal that the contents of a web page should be decrypted. When the user selects the decrypt button, the decrypt web page component may defer the decrypting of the content of the web page until the signal indicated by the template has been received. In block 3301, the component retrieves the URL for the web page. In block 3302, the component retrieves the template for that URL. In block 3303, the component awaits for the signal indicated in the template. In blocks 3304-3307, the block loops, selecting each command of the template and decrypting the web page in accordance with the selected command. In block 3304, the component selects the next command of the template. In decision block 3305, if all the commands have already been selected, then the component completes, else the component continues at block 3306. In block 3306, the component decrypts using the user's private key a portion of the web page as indicated by the selected command. In block 3307, the component adds the decrypted portion back to the web page in accordance with the selected command and then loops to block 3304 to select next command.

From the above description, it will be appreciated that although various embodiments have been described for purposes of illustration, the invention is not limited to these embodiments. Accordingly, the invention is not limited except by the following claims.

1. A method in a client computer for encrypting an electronic mail message, the method comprising:
receiving an indication to encrypt the electronic mail message, the electronic mail message having a recipient electronic mail address;
retrieving from a local key store a public key associated with the recipient electronic mail address;
when the public key cannot be retrieved from the local key store, retrieving from a key server the public key associated with the recipient electronic mail address; and
encrypting the electronic mail message using the retrieved public key.

2. The method of claim I including sending the encrypted electronic mail message to the recipient electronic mail address.

3. The method of claim 1 wherein the retrieving from the key server includes:
sending to the key server a request for the public key associated with the recipient electronic mail address; and
receiving from the key server a response including the public key associated with the recipient electronic mail address.

4. The method of claim 1 wherein when the key server does not already have a public key associated with the recipient electronic mail address, the key server associates a new public and private key pair with the recipient electronic mail address.

5. The method of claim 4 wherein the key server sends a notification electronic mail message to the recipient electronic mail address describing how to access the new private key associated with the recipient electronic mail message.

6. The method of claim 5 wherein the notification electronic mail message includes an authentication code so that a user accessing the new private key can be authenticated by presentment of the authentication code.

7. The method of claim 5 wherein the notification electronic mail message includes a link to a web site through which the new private key can be accessed.

8. The method of claim 5 wherein the new private key is an interim key.

9. The method of claim 1 including storing the public key retrieved from the key server in the local key store.

10. The method of claim 9 wherein when the public key retrieved from the key server is an interim key, suppressing the storing of the public key in the local key store.

11. The method of claim 1 including
sending to the key server a request for the public key associated with the recipient electronic mail address;
receiving from the key server a response indicating that no public key is associated with the recipient electronic mail address; and
in response to receiving the response,
sending to the key server a request that a public and private key pair be associated with the recipient electronic mail address; and
receiving from the key server a response including the public key newly associated with the recipient electronic mail address.

12. The method of claim 1 wherein the electronic mail message is to be sent by a sender and including logging the sender on to the key server.

13. The method of claim 1 including signing the electronic mail message with a private key associated with a sender of the electronic mail message.

14. The method of claim 1 wherein when the encrypted electronic mail message is received at the recipient electronic mail address, the encrypted electronic mail message is automatically decrypted using a private key associated with the recipient electronic mail address.

15. The method of claim 1 wherein when a recipient receives the encrypted electronic mail message, the decrypting of the received electronic mail message is deferred until a request to decrypt is received.

16. A method in a server computer for coordinating sending of an electronic mail message from a sender to a recipient, the method comprising:
receiving from a sender computer a request for a public key associated with a recipient electronic mail address;
associating a public and private key pair with the recipient electronic mail address;
sending to the sender computer a response that includes the public key associated with the recipient electronic mail address; and
providing the private key to the recipient
so that the electronic mail message encrypted by the sender using the public key can be decrypted by the recipient using the private key.

17. The method of claim 16 wherein the providing of the public key to the recipient includes sending a notification electronic mail message to the recipient electronic mail address.

18. The method of claim 17 wherein the notification electronic mail message includes an authentication code that is used to authenticate the recipient when the interim private key is provided to the recipient.

19. The method of claim 17 wherein the notification electronic mail message includes the private key.

20. The method of claim 16 including when a subsequent request is received from a sender computer for a public key associated with the recipient electronic mail address, sending to the sender computer the public key previously associated with the recipient electronic mail address.

21. The method of claim 16 wherein the public key is an interim key and the sender computer does not persistently store the interim public key.

22. The method of claim 16 wherein the public and private key pair is used as a permanent public and private key pair for the recipient.

23. The method of claim 16 wherein the public and private pair is used as a permanent public and private key pair for the recipient when requested by to do so by the recipient.

24. The method of claim 16 including receiving a permanent public key from the recipient and replacing the public key with the received permanent public key.

25. The method of claim 16 including generating the public and private key pair.

26. The method of claim 16 including selecting the public and private key pair from a pool of previously generated public and private key pairs.

27. The method of claim 26 including changing an electronic mail address associated with the selected public and private key pair to the recipient electronic mail address.

28. A method in a server computer for coordinating sending of an electronic mail message from a sender to a recipient, the method comprising:
receiving from a sender computer a request to send the electronic mail message to a recipient electronic mail address;
encrypting the electronic mail message with a public key associated with the recipient;
sending the encrypted electronic mail message to the recipient electronic mail address; and
sending a private key to the recipient so that the electronic mail message can be decrypted by the recipient using the sent private key.

29. The method of claim 28 wherein the sending of the private key to the recipient includes sending of a notification electronic mail message to the recipient electronic mail address.

30. The method of claim 29 wherein the notification electronic mail message includes an authentication code that is used to authenticate the recipient before sending the private key.

31. The method of claim 29 wherein the notification electronic mail message includes the private key.

32. The method of claim 28 wherein the public and private key pair is used as a permanent public and private key pair for the recipient electronic mail address.

33. The method of claim 28 wherein the public and private pair is used as a permanent public and private key pair for the recipient electronic mail address when requested by to do so by the recipient.

34. The method of claim 28 including receiving a permanent public key from the recipient and replacing the public key with the received permanent public key.

35. The method of claim 28 including generating the public and private key pair after the request is received.

36. The method of claim 28 including selecting the public and private key pair from a pool of previously generated public and private key pairs.

37. The method of claim 36 including changing an electronic mail address associated with the selected public and private pair to the recipient electronic mail address.

38. A method in a client computer for encrypting digital data, the method comprising:
receiving an indication to encrypt digital data;
retrieving from a local key store a locking key associated with a user;
when the locking key cannot be retrieved from the local key store, retrieving from a key server the locking key associated with the user; and
encrypting the digital data using the retrieved locking key.

39. The method of claim 38 wherein the user has a user identifier and the locking key is mapped to the user identifier.

40. The method of claim 39 wherein the user identifier is an electronic mail address.

41. The method of claim 39 wherein the user identifier is a key identifier associated with the locking key.

42. The method of claim 39 wherein the user identifier is a user name.

43. The method of claim 38 wherein the encrypted digital data is decrypted using an unlocking key.

44. The method of claim 38 wherein the locking key is a public key of a public and private key pair.

45. The method of claim 38 wherein the digital data is content of a file.

46. The method of claim 38 wherein the digital data is content of an electronic mail message.

47. The method of claim 38 wherein the key server receives a request for a locking key for the user, it assigns a locking and unlocking key pair to the user and provides the unlocking key to the user.

48. The method of claim 47 wherein the key server notifies the user that a locking and unlocking key pair has been assigned to the user before providing the unlocking key to the user.

49. The method of claim 48 wherein the key server provides an authentication code for authenticating the user.
